(19) United States
(12) Patent Application Publication
(10) Pub. No.: US 2025/0311749 A1
(43) Pub. Date: Oct. 9, 2025

(54) NON-ANIMAL PROTEIN BLENDS AND COMPOSITIONS CONTAINING SAME

(71) Applicant: THE COCA-COLA COMPANY, Atlanta, GA (US)

(72) Inventors: Cynthia FRANCIS, Atlanta, GA (US); Haiyu REN, Atlanta, GA (US); Robert KRIEGEL, Atlanta, GA (US); Christopher MERCOGLIANO, Atlanta, GA (US); Omri DUEK, Atlanta, GA (US)

(21) Appl. No.: 18/864,759

(22) PCT Filed: May 12, 2023
(86) PCT No.: PCT/US23/21987

§ 371 Date: Nov. 11, 2024

Related U.S. Application Data
(60) Provisional application No. 63/341,773, filed on May 13, 2022.

(51) Int. Cl. A23J 3/14; A23J 3/04; A23J 3/08; A23L 2/66

(52) U.S. Cl. CPC A23J 3/14; A23J 3/04; A23J 3/08; A23L 2/66

(57) ABSTRACT

Described are non-animal protein blends comprising legume protein, and one or more of synthetic protein, seed protein, and grain protein, wherein the blend has a PDCAAS of 1. Compositions comprising these blends and methods of using them are also disclosed.

### CROSS-REFERENCE TO RELATED APPLICATIONS

This application claims the benefit of priority to U.S. Provisional Application No. 63/341,773, filed on May 13, 2022, which is incorporated by reference herein in its entirety.

### TECHNICAL FIELD

The present disclosure relates to plant-based protein mixtures, nutritional compositions and supplements comprising said mixtures, and methods of using the same.

### BACKGROUND

Vegetarian diets rely on plant sources like fruits, vegetables, nuts, and whole grains, rather than on animal sources such as meat and dairy. While vegetarian diets are popular for a variety of reasons, the protein intake from vegetarian diets can be lower than meat-based diets and thus they may not contain sufficient amounts of essential amino acids that a human body needs. The nine essential amino acids often lacking in a vegetarian diet are histidine, isoleucine, leucine, lysine, methionine, phenylalanine, threonine, tryptophan, and valine.

To evaluate the quality of a dietary protein, the US FDA and the Food and Agricultural Organization of the United Nations/World Health Organization (FAO/WHO) in 1993 adopted the Protein Digestibility-Corrected Amino Acid Score (PDCAAS) as a method based on both the amino acid requirements of humans and their ability to digest the protein. Since then, the PDCAAS score has been recognized as the preferred method to determine protein quality. Proteins are evaluated on a scale of PDCAAS 0 to 1 with 1 being the highest. PDCAAS is calculated as:

$$PDCAAS = ( \frac{mg of limiting amino acid in 1 g of test protein}{mg of same amino acid in 1 g of referenced protein} ) \times fecal true digestibility percentage$$

The reference protein essential amino acid profile is chosen as the amino acid requirement pattern for the 2-5-year-old child, which is shown in Table 1.

TABLE 1
Essential Amino Acid Profile of Reference
Protein for PDCAAS determination

| | mg/g of |
|---|---|
| Essential Amino Acid | protein |
| Histidine | 19 |
| Isoleucine | 28 |
| Leucine | 66 |
| Lysine | 58 |
| Methionine + Cystine | 25 |
| Phenylalanine + | 63 |
| Threonine | 34 |
| Tryptophan | 11 |
| Valine | 35 |

Animal-based proteins such as casein, whey, and egg white score 1.00 on the PDCAAS scale, while plant-based foods and proteins typically have lower scores. For example, vegetables have scores ranging between 0.7-0.89, fresh fruit between 0.64-0.76, and legumes between 0.7-0.89. One way to resolve the incomplete amino acid profile of plant-based protein is to prepare a protein blend that can serve as a complete and well-balanced source of amino acids for human physiological requirements. To calculate PDCAAS for a protein blend, take the weighted average of individual amino acids of each protein in the blend to determine the limiting amino acid, and the weight average of digestibility percentage of each protein and substitute these numbers in the equation above. While protein blends can have PDCAAS scores higher than 1, standard practice is to truncate the score to 1.

Obtaining a non-animal protein blend with a PDCAAS of 1 can be a challenging task. Proteins obtained from different vendors can have different amino acid profiles, the availability of proteins may differ, and the dietary preferences of certain regions can differ. These factors and others contribute to the difficulty of finding a suitable blend that has a PDCAAS of 1. Further, many vegetarian diets rely heavily on soy protein, which has a complete amino acid profile with high digestibility. But soy can be allergenic, it contains phytoestrogens that can affect the activity of natural estrogen in human body, and it has sustainability challenges related to land and fertilizer use. Moreover, mixing different non-animal protein sources brings associated challenges of taste, cost, and whether the blend can be used in a shelf-stable beverage product. Thus, what are needed are blends of non-animal proteins that do not rely on soy protein as the main source of protein, that have a PDCAAS of 1, and that have desirable taste. The compositions and methods disclosed herein address these and other needs.

### SUMMARY

Disclosed herein are compounds, compositions, methods for making and using such compounds and compositions. In one aspect, disclosed are non-animal protein blends comprising legume protein, and one or more of synthetic protein, seed protein, and grain protein, wherein the blend has a PDCAAS of 1. In one aspect, disclosed are non-animal protein blends comprising legume protein, β-lactoglobulin, and optionally grain protein, wherein the blend has a PDCAAS of 1. In another aspect, disclosed are non-animal protein blends comprising legume protein, seed protein, and optionally grain protein, wherein the blend has a PDCAAS of 1. In a still further aspect, disclosed are non-animal protein blends comprising ovomucoid protein, legume protein, seed protein, and optionally grain protein, wherein the blend has a PDCAAS of 1. The disclosed blends do not contain an animal protein, but can optionally contain one or more of a fiber, prebiotic, probiotic, digestive enzyme, sweetener, flavorant, colorant, vitamin, and mineral.

In some examples of the disclosed blends, the legume protein can be chickpea protein, pea protein, lentils protein, or a combination thereof. In other examples, the seed protein can be canola protein, sacha inchi protein, or combinations thereof. In other examples, the grain protein can be oat protein.

Compositions and beverages comprising the disclosed blends are also described herein, as are methods of making and using said blends and compositions.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

The present invention can be understood more readily by reference to the following detailed description of the invention and the Examples included therein.

Before the present compounds, compositions, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

### General Definitions

In this specification and in the claims that follow, reference will be made to a number of terms, which shall be defined to have the following meanings:

As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

Throughout the present specification, numerical ranges are provided for certain quantities. It is to be understood that these ranges comprise all values and subranges therein. Thus, the range “from 50 to 80” includes all possible values therein (e.g., 50, 51, 52, 53, 54, 55, 56, etc.) and all possible ranges therein (e.g., 51-79, 52-78, 53-77, 54-76, 55-75, 60-70, etc.). Furthermore, all values within a given range may be an endpoint for the range encompassed thereby (e.g., the range 50-80 includes the ranges with endpoints such as 55-80, 50-75, etc.).

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. In specific examples, “about” is meant to be within 5%, 4%, 3%, 2%, or 1% of the stated value.

The term “a” or “an” refers to one or more of that entity; for example, “a protein” refers to one or more proteins. As such, the terms “a” (or “an”), “one or more” and “at least one” are used interchangeably herein. In addition, reference to “a protein” by the indefinite article “a” or “an” does not exclude the possibility that more than one of the proteins is present, unless the context clearly requires that there is one and only one of the proteins.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight component Y, X and Y are present at a weight ratio of 2:5, and are present in such ratio regardless of whether additional components are contained in the mixture.

A weight percent (wt. %) of a component, unless specifically stated to the contrary, is based on the total weight of the formulation or composition in which the component is included.

The term “amino acid” refers to the natural amino acids alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine.

As used herein, the terms “administering” and “administration” refer to any method of providing a preparation to a subject. Such methods are well known to those skilled in the art. In preferred methods, administration refers to oral administration. Administration can be continuous or intermittent. In some examples, a preparation can be administered therapeutically; that is, administered to treat an existing disease or condition. In some examples, a preparation can be administered prophylactically; that is, administered for prevention of a disease or condition.

A “dosage form” comprises any preparation, or combination of preparations, that provides a desired dosage. Hence a dosage form can include a single composition (such as a powdered beverage mix or other ingestible preparation) or a combination of several different compositions (such as a powdered beverage mix, a snack and a supplement). A dosage form can “provide a daily dosage” in either a single unit dosage form (such as a tablet or a liquid beverage in which the powder mix is dispensed) or in multiple dosages taken at different times throughout a day. Hence a dosage form that includes multiple sub-dosage forms can provide the total daily dosage administered at different times during a day (for example at breakfast and lunch), and in different forms (for example as a liquid beverage and a chewable snack bar). A particular example of a dosage form is an artificial preparation that includes a pharmaceutical carrier. A further distinction can be drawn between an exogenous preparation and a food preparation, wherein an exogenous preparation is in addition to consumed conventional food.

As used herein, the terms “effective amount” and “amount effective” refer to an amount that is sufficient to achieve the desired result or to have an effect on an undesired condition. The specific effective amount for any particular subject will depend upon a variety of factors including the age, body weight, general health, sex and diet of the subject. For example, it is well within the skill of the art to start doses of a composition at levels lower than those required to achieve the desired effect and to gradually increase the dosage until the desired effect is achieved. If desired, the effective daily amount can be divided into multiple doses for purposes of administration. Consequently, single dose compositions can contain such amounts or submultiples thereof to make up the daily dose.

“Optional” or “optionally” means that the subsequently described event or circumstance can or cannot occur, and that the description includes instances where the event or circumstance occurs and instances where it does not.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, characteristic, component, composition, or other condition for which substantially is used to characterize or otherwise quantify an amount. es where said event or circumstance occurs and instances where it does not.

Disclosed are the components to be used to prepare the compositions disclosed herein as well as the compositions themselves to be used within the methods disclosed herein. These and other materials are disclosed herein, and it is understood that when combinations, subsets, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions disclosed herein. Thus, if there are a variety of additional steps that can be performed it is understood that each of these additional steps can be performed with any specific embodiment or combination of embodiments of the methods disclosed herein.

As used herein, the terms “individual” or “subject” refer to an animal, such as a mammal, for example a human.

Reference will now be made in detail to specific aspects of the disclosed materials, compounds, compositions, articles, and methods, examples of which are illustrated in the accompanying Examples.

### Protein Blends

Disclosed herein are blends of non-animal proteins that together have a PDCAAS of 1. The disclosed blends can also have desirable taste alone or in a beverage or food composition. The protein blends disclosed herein comprise more than one non-animal, proteins. Typically, the blends comprise two non-animal proteins, three non-animal proteins, four non-animal proteins, or five non-animal proteins. While more than five non-animal proteins can be used, it is preferable to use two or three non-animal proteins.

The disclosed non-animal protein blends comprise proteins in at least two groups as shown in Table 2. For example, the blends can comprise non-animal proteins from Group 1 and 2, from Group 1 and 3, from Group 1 and 4, from Group 1 and 5, from Group 1 and 6, from Group 2 and 3, from Group 2 and 4, from Group 2 and 5, from Group 2 and 6, from Group 3 and 4, from Group 3 and 5, from Group 3 and 6, from Group 4 and 5, from Group 4 and 6, or from Group 5 and 6, where any of these combinations can optionally include one or more additional proteins from Group 1, 2, 3, 4, 5, and/or 6, as long as the PDCAAS of the blend is 1.

TABLE 2
Groups of non-animal protein

| Group 1 | | | | | Group 6 |
|---|---|---|---|---|---|
| Synthetic/ | Group 2 | Group 3 | Group 4 | Group 5 | Tubers/ |
| Lab-Made | Grains | Legumes | Nuts | Seeds | Roots |
| β-lactoglobulin | rice | peas | almonds | pumpkin | potato |
| ovomucoid | barley | lentils | Brazil nuts | flaxseed | |
| β-casein | quinoa | peanuts | cashew nuts | sesame | |
| k-casein | corn | mung | hazelnuts | poppy | |
| | | beans | | | |
| αSi-casein | wheat | pinto beans | macadamias | sunflower | |
| | oats | navy beans | pecans | chia | |
| | buckwheat | lima beans | pine nuts | sacha inchi | |
| | rye | kidney | pistachios | Canola/ | |
| | | beans | | rapeseed | |
| | | soybeans | walnuts | | |
| | | chickpeas | | | |
| | | fava beans | | | |
| | | black-eyed | | | |
| | | peas | | | |
| | | carob | | | |
| | | beans | | | |
| | | lupin beans | | | |

In one aspect, disclosed is a non-animal protein blend comprising a legume protein and one or more of a synthetic protein, seed protein, nut protein, and grain protein, wherein the blend has a PDCAAS of 1. In specific examples, the legume protein can be chickpea protein, pea protein, lentils protein, mung bean protein, soybean protein, pinto bean protein, lupin bean protein, carob bean protein, or any combination thereof. In other examples the seed protein is present and can be canola protein, sacha inchi protein, flaxseed protein, sesame protein, sunflower protein, poppy protein, pumpkin protein, or any combination thereof. In specific examples, the nut protein is present and can be almond protein, walnut protein, cashew nut protein, hazelnut protein, pecan protein, pistachio protein, or any combination thereof. In specific examples, the grain protein is present and can be oat protein, rice protein, barley protein, quinoa protein, wheat protein, corn protein, rye protein, or any combination thereof.

In one aspect, disclosed is a non-animal protein blend comprising legume protein, β-lactoglobulin, and optionally grain protein. In specific examples, the legume protein can be chickpea protein, pea protein, or a combination of both. In other examples, the grain protein can be oat protein.

In one aspect, disclosed is a non-animal protein blend comprising legume protein, seed protein, and optionally grain protein. In specific examples, the legume protein can be chickpea protein. In specific examples, the seed protein can be canola protein. In other examples, the seed protein is sacha inchi protein. In other examples, the grain protein can be oat protein.

In one aspect, disclosed is a non-animal protein blend comprising ovomucoid protein, legume protein, seed protein, and optionally grain protein. In specific examples, the legume protein can be chickpea protein. In other examples, the seed protein can be sacha inchi protein. In other examples, the grain protein can be oat protein.

In one aspect, disclosed is a non-animal protein blend comprising from about 25 to about 50 wt. % legume protein, from about 41 to about 50 wt. % of synthetic protein, and from about 0 to about 34 wt. % grain protein. In specific examples, the legume protein can be chickpea protein. In other examples, the grain protein can be oat protein.

In one aspect, disclosed is a non-animal protein blend comprising from 20 to about 87 wt. % legume protein, from about 14 to about 37 wt. % synthetic protein, and from about 0 to about 26 wt. % grain protein. In specific examples, the legume protein can be chickpea protein, pea protein, or a combination of both. In some examples, the blend can comprise from about 0 to about 43 wt. % chickpea protein. In other examples, the grain protein can be oat protein.

In one aspect, disclosed is a non-animal protein blend comprising from about 55 to about 60 wt. % legume protein, from about 40 to about 45 wt. % seed protein, and from about 0 to about 1 wt. % grain protein. In specific examples, the legume protein can be chickpea protein. In other examples the seed protein can be canola protein. In other examples, the grain protein can be oat protein.

In one aspect, disclosed is a non-animal protein blend comprising from about 1 to about 65 wt. % legume protein and from about 33 to about 45 wt. % seed protein. In specific examples, the legume protein can be chickpea protein, pea protein, lentils protein, or any combination thereof. In specific examples, the blend can comprise from about 0 to about 53 wt. % chickpea protein, from about 1 to about 65 wt. % pea protein and/or from about 0 to about 25 wt. % of lentils protein. In other examples, the seed protein can be sacha inchi protein.

In one aspect, disclosed is a non-animal protein blend comprising from about 1 to about 29 wt. % synthetic protein, from about 37 to about 92 wt. % legume protein, from about 7 to about 34 wt. % seed protein, and from about 0 to about 1 wt. % grain protein. In specific examples, the legume protein can be chickpea protein. In other examples, the seed protein can be sacha inchi protein. In other examples, the grain protein can be oat protein.

In all of the non-animal protein blends disclosed herein, the blends do not contain animal protein, e.g., dairy proteins like whey protein or casein. In other examples, the non-animal protein blends disclosed herein are substantially free of animal proteins.

Proteins suitable for use herein can be sourced as individual proteins, concentrates, or isolates from plants. Some can also come from precision fermentation, from cell culture methods, from plant genetic engineering methods, from fermented microorganisms.

### Beverages

Also disclosed herein are nutritional beverages that comprise a non-animal protein blend having a PDCAAS of 1, as described herein. In specific aspects, beverages are provided that include from about 1 to about 14 grams of protein per about 2 to about 32 fluid ounces, for example, from about 4 to about 24 fluid ounces, from about 6 to about 18 fluid ounces, from about 10 to about 16 fluid ounces, or about 12 fluid ounces. The beverage can be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, or 32 fluid ounces, where any of these values can form an upper or lower endpoint of a range. In specific aspects, beverages are provided that include from about 1 gram to about 14 grams, about 2 grams to about 12 grams, about 3 grams to about 10 grams, or about 5 grams to about 8 grams per 8 ounce serving, or greater than about 1 gram, about 2 grams, about 3 grams, about 4 grams, about 5 grams, about 6 grams, about 7 grams, about 8 grams, about 9 grams, about 10, grams, about 11 grams, about 12 grams, about 13 grams, or about 14 grams per 8 ounce serving, where any of the stated values can form an upper or lower endpoint of a range.

Nutritional beverages disclosed herein can also comprise water. Water can be present at a level of from about 80% to about 99.9%, from about 89% to about 99%, from about 88% to about 98%, or from about 87% to about 97% by weight of the beverage, or at a level of about 80%, 81%, 82%, 83%, 84%, 85%, 86%, 87%, 88%, 89%, 90%, 91%, 92%, 93%, 94%, 95%, 96%, 97%, 98% or about 99% by weight of the beverage, where any of these values can form an upper or lower endpoint of a range. The nutritional beverage can be a ready to drink liquid formulation, frozen ready-to-drink beverages, coffee beverages (e.g., green coffee and/or roasted coffee), tea beverages, powdered beverages, liquid concentrates, flavored waters, fruit juice, and fruit juice-flavored beverages. In some examples, the beverages are non-dairy beverages.

Specific amino acids that can be present in the disclosed beverages include, but are not limited to, histidine, which can be present in an amount of at least about 4, at least about 6, at least about 8, or at least about 10 mg/g; isoleucine, which can be present in an amount of at least about 6, at least about 7, at least about 8, or at least about 9 mg/g; leucine, which can be present in an amount of at least about 14, at least about 16, at least about 17, or at least about 18 mg/g; lysine, which can be present in an amount of at least about 10, at least about 11, at least about 12, or at least about 13 mg/g; methionine, which can be present in an amount of at least about 2, at least about 3, at least about 4, or at least about 5 mg/g; phenylalanine, which can be present in an amount of at least about 6, at least about 7, at least about 8, or at least about 9 mg/g; threonine, which can be present in an amount of at least about 10, at least about 12, at least about 14, or at least about 16 mg/g; tryptophan, which can be present in an amount of at least about 0.1, at least about 1, at least about 1.5, or at least about 2.0 mg/g; and valine, which can be present in an amount of at least about 10, at least about 12, at least about 14, or at least about 16 mg/g.

### Foods

Also disclosed are food articles that comprise a non-animal protein blend having a PDCAAS of 1, as described herein. The food articles can be any article that can be consumed (e.g., eaten, or drank) by a subject. Examples of suitable food articles that can contain the disclosed non-animal blends are confectionaries, gums, gummies, chews, breads, cereals, and snack bars. The foods can comprise from 1 gram to about 14 grams, about 2 grams to about 12 grams, about 3 grams to about 10 grams, or about 5 grams to about 8 grams per 8 ounce serving, or greater than about 1 gram, about 2 grams, about 3 grams, about 4 grams, about 5 grams, about 6 grams, about 7 grams, about 8 grams, about 9 grams, about 10, grams, about 11 grams, about 12 grams, about 13 grams, or about 14 grams per 8 ounce serving, where any of the stated values can form an upper or lower endpoint of a range.

### Method

Also disclosed herein is a method of providing protein to an individual that includes administering to the individual a nutritional beverage as disclosed herein and having from about 2 grams to about 10 grams of a non-animal protein blend as disclosed herein. In specific examples, the individual can be administered in a given day 4 fluid ounces, 8 fluid ounces, 12 fluid ounces, 16 fluid ounces, 20 fluid ounces, 24 fluid ounces, 28 fluid ounces, 32 fluid ounces, 36 fluid ounces, 40 fluid ounces, 44 fluid ounces, 48 fluid ounces, 52 fluid ounces, 56 fluid ounces, or 60 fluid ounces of the disclosed nutritional beverage.

### Additional Components

The disclosed non-animal blends or compositions that comprise them (e.g., beverages, foods, supplements) can contain additional ingredients, such as, fibers, prebiotics, probiotics, digestive enzymes, sweeteners, flavorants, colorants, preservatives, vitamins, and minerals. Examples of suitable fibers include water-soluble fibers such as alginate, beta-glucan, carrageenan, cellulose, chitosan, chitin, hydrolyzed guar, galactooligosaccharide, hemicellulose, hydroxymethylcellulose, hydroxypropylmethylcellulose, inulin, inulose, resistant maltodextrin, mucilage, pectin, psyllium husk, polydextrose, xanthan, vegetable gum fibers (e.g., guar gum, acacia Senegal gum and the like). Fiber can be present in the final composition at from about 0.01 wt. % to about 15 wt. % of the total composition.

Prebiotics are oligosaccharides that service as the energy source for probiotics and promote the growth of probiotics. Examples of suitable prebiotics are fructooligosaccharides, galactooligosaccharides, inulin, and xylooligosaccharides.

Probiotics are living microbial organisms that can enhance the microbial environments in human digestive tract and promote the digestive health. Examples of suitable probiotics are Bifidobacterium such as the strains B. adolescentis, B. animalis, B. bifidum, B. longum, B. thermophilwn, Lactobacillus, such as the strains L. acidophilus, L. brevis, L. casei, L. bulgaricus, L. fermentum, L. GG, L. lactis, L. plantarum, L. reuteri, L. rhumnosus, L. salivarius, Bacillus cereus toyoi, Bacillus cereus, Bacillus couguluns, Streptococcus such as the strains S. cremoris, S. infantarius, S. intermedius, and S. lactis.

In aid in digestive health and nutrient absorption, further additives to a nutritional powdered protein shakes are digestive enzymes such as amylase, lipase, protease, cellulase, alpha-galactosidase, amyloglucosidase, beta-glucanase, bromelain, dextranase, pepsin, hemicellulase, invertase, trypsin, pectinase, papain, peptidase, and xylanase.

Exemplary sweeteners that can be added include nutritive and/or non-nutritive sweeteners such as cane sugar, sugar syrup, tapioca syrup, honey, HFCS (“High Fructose Corn Syrup”), FIS (“Fully Inverted Sugar”), MIS (“Medium Inverted Sugar”), erythritol, aspartame, Ace-K, steviol glycosides (e.g., Reb A, Reb M), sucralose, saccharin, allulose, glucose, sucrose, stevia, fruit juice or extract, or combinations thereof.

Exemplary flavorings that can be suitable for the disclosed blends and compositions include coffee flavoring, jasmine tea flavoring, berry (e.g., pomegranate-blueberry, mixed berry, etc.) flavoring, citrus (e.g., lemon, lemon-grapefruit, etc.) flavoring, fruit punch flavoring, spice (e.g., ginger) flavoring and others. Certain formulations will have no added flavoring. Preservatives can be added if desired, depending upon the other ingredients, production technique, desired shelf life, etc. Optionally, caffeine can be added.

Exemplary preservatives that can be used in the disclosed blends and compositions include benzoates, e.g., sodium, calcium, and potassium benzoate, sorbates, e.g., calcium and potassium sorbate, citrates, e.g., sodium and potassium citrate, polyphosphates, e.g., sodium hexametaphosphate (SHMP), and mixtures thereof. Antioxidants such as ascorbic acid, EDTA, BHA, BHT, TBHQ, dehydroacetic acid, dimethyldicarbonate, ethoxyquin, heptylparaben, and combinations thereof, can also be included in the disclosed blends.

Specific vitamins that can be present in the disclosed blends and compositions include, but are not limited to, vitamin A, vitamin C, B1 (Thiamin), B2 (Riboflavin), B3 (Niacin), B6 (Pyridoxine), vitamin D, and folic acid.

Specific minerals that can be present in the disclosed blends and compositions include, but are not limited to, calcium, potassium, magnesium, manganese, sodium, phosphorous, or zinc.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers, but some errors and deviations should be accounted for. Unless indicated otherwise, parts are parts by weight, temperature is in ° C. or is at ambient temperature, and pressure is at or near atmospheric.

### Examples 1-17

The following combinations of non-animal proteins were found to contain a PDCAAS of 1.

TABLE 3
Examples of Non-animal Protein Blends

| | | Mix with | Mix with | Mix with |
|---|---|---|---|---|
| Example | Core proteins | Protein 1 | Protein 2 | Protein 3 |
| | b-lactoglobulin | Chickpea | Oat | |
| | (41-50%) | (25-50%) | (0-34%) | |
| 1 | 50% | 50% | 0% | |
| 2 | 41% | 25% | 34% | |
| | b-lactoglobulin | Chickpea | Oat | Pea |
| | (14-37%) | (0-43%) | (0-26%) | (20-87%) |
| 3 | 14% | 0% | 0% | 87% |
| 4 | 35% | 0% | 26% | 39% |
| 5 | 37% | 43% | 0% | 20% |
| 6 | 15% | 1% | 1% | 84% |
| | Chickpea | Canola | Oat | |
| | (55-60%) | (40-45%) | (0-1%) | |
| 7 | 60% | 40% | 0% | |
| 8 | 55% | 45% | 1% | |
| | Pea | Chickpea | Sacha inchi | Lentils |
| | (1-65%) | (0-53%) | (33-45%) | (0-25%) |
| 9 | 38% | 0% | 37% | 25% |
| 10 | 65% | 0% | 33% | 0% |
| 11 | 1% | 53% | 45% | 0% |
| | Ovomucoid | Oat | Chickpea | Sacha inchi |
| | (1-29%) | (0-1%) | (37-92%) | (7-34%) |
| 12 | 29% | 0% | 37% | 34% |
| 13 | 1% | 1% | 92% | 7% |
| | Chickpea | Brown rice | Sacha inchi | Oat |
| | (63-70%) | (0-25%) | (5-26%) | (0-25%) |
| 14 | 63% | 12% | 26% | 0% |
| 15 | 70% | 25% | 5% | 0% |
| 16 | 63% | 0% | 26% | 12% |
| 17 | 70% | 0% | 5% | 25% |

### Taste Test:

Examples 14, 15, and 17, along with a commercially available pea protein as a control, were taste tested.

| | | | Neither | |
|---|---|---|---|---|
| | Dislike | Dislike | like nor | Like |
| Protein Blends | very much | somewhat | dislike | somewhat |
| Commercial pea protein | 40% | 40% | 20% | |
| Example 14 (with cane sugar) | 20% | 40% | 20% | 20% |
| Example 14 (cane sugar replaced | | | 60% | 40% |
| with tapioca syrup) | | | | |
| Example 15 (with cane sugar) | | | 80% | 20% |
| Example 15 (with cane sugar, gellan | 20% | | 20% | 60% |
| and acacia gum) | | | | |
| Example 17 | | | | 100% |

1. A non-animal protein blend comprising a legume protein, and one or more of a synthetic protein, a seed protein, a nut protein, and a grain protein, wherein the blend has a PDCAAS of 1.

2. The blend of claim 1, comprising the legume protein, the synthetic protein, and optionally the grain protein.

3. The blend of claim 1, comprising the legume protein, the synthetic protein, the seed protein, and optionally the grain protein.

4. The blend of claim 1, comprising the legume protein, seed protein, and optionally grain protein.

5. The blend of claim 1, wherein the legume protein is chickpea protein, pea protein, lentils protein, mung bean protein, soybean protein, pinto bean protein, lupin bean protein, carob bean protein, or any combination thereof.

6. The blend of claim 1, wherein the seed protein is present and is canola protein, sacha inchi protein, flaxseed protein, sesame protein, sunflower protein, poppy protein, pumpkin protein, or any combination thereof.

7. The blend of claim 1, wherein the nut protein is present and is almond protein, walnut protein, cashew nut protein, hazelnut protein, pecan protein, pistachio protein, or any combination thereof.

8. The blend of claim 1, wherein the grain protein is present and is oat protein, rice protein, barley protein, quinoa protein, wheat protein, corn protein, rye protein, or any combination thereof.

9. The blend of claim 1, comprising from about 25 to about 50 wt. % legume protein, from about 41 to about 50 wt. % synthetic protein, and from about 0 to about 34 wt. % grain protein.

10. The blend of claim 9, wherein the legume protein is chickpea protein, the synthetic protein is β-lactoglobulin, and the grain protein is oat protein.

11. The blend of claim 1, comprising from about 20 to about 87 wt. % legume protein, from about 14 to about 37 wt. % synthetic protein, and from about 0 to about 26 wt. % grain protein.

12. The blend of claim 11, comprising from about 0 to about 43 wt. % chickpea protein, from about 20 to about 87 wt. % pea protein, and the grain protein is oat protein.

13. The blend of claim 1, comprising from about 55 to about 60 wt. % legume protein, from about 40 to about 45 wt. % seed protein, and from about 0 to about 1 wt. % grain protein.

14. The blend of claim 13, wherein the legume protein is chickpea protein, the seed protein is canola protein, and the grain protein is oat protein.

15. The blend of claim 2, wherein the synthetic protein is β-lactoglobulin.

16. The blend of claim 3, comprising from about 1 to about 65 wt. % legume protein and from about 33 to about 45 wt. % seed protein.

17. The blend of claim 16, comprising from about 0 to about 53 wt. % chickpea protein, from about 1 to about 65 wt. % pea protein, and/or from about 0 to about 25 wt. % of lentils protein, and the seed protein is sacha inchi protein.

18. The blend of claim 3, comprising from about 1 to about 29 wt. % ovomucoid protein, from about 37 to about 92 wt. % legume protein, from about 7 to about 34 wt. % seed protein, and from about 0 to about 1 wt. % grain protein.

19. The blend of claim 18, wherein the legume protein is chickpea protein, the seed protein is sacha inchi protein, and the grain protein is oat protein.

20. (canceled)

21. The blend of claim 1, further comprising one or more of a fiber, prebiotic, probiotic, digestive enzyme, sweetener, flavorant, colorant, preservative, vitamin, and mineral.

22. (canceled)

23. A beverage comprising the blend of claim 1.
